(19) United States
(12) Patent Application Publication
(10) Pub. No.: US 2026/0335847 A1
(43) Pub. Date: Oct. 29, 2026

(54) CONTAINER, MIXING DEVICE AND METHOD OF USING A MIXING DEVICE

(71) Applicant: HOMBRECHTIKON SYSTEMS ENGINEERING AG, Hombrechtikon (CH)

(72) Inventors: Konstantin LUTZE, Uerikon (CH); Timo DÜRING, Zürich (CH); Kevin SELINER, Kaltbrunn (CH); Pascal Sandro HAAS, Neuhaus SG (CH); Rafael BÖTSCHI, Volketswil (CH); Fabio Luca THON, Feldbach (CH); Manuel BECKER, Vilters (CH)

(21) Appl. No.: 19/116,070

(22) PCT Filed: Oct. 5, 2022
(86) PCT No.: PCT/EP2022/077728

§ 371 Date: Mar. 27, 2025

(51) Int. Cl. B01F 31/55; B01F 35/51; B01F 35/513; B01F 35/52; B01F 101/22; B03C 1/28

(52) U.S. Cl. CPC B01F 31/55; B01F 35/51; B01F 35/513; B01F 35/52; B03C 1/288; B01F 2101/22

(57) ABSTRACT

A mixing device with a container, the mixing device includes first and second pressing surfaces, and the container is capable of being arranged between the first and the second pressing surfaces in such a way that the container can be deformed by the first or the second pressing surface so that a content in the interior space can be mixed.

### CROSS-REFERENCE TO RELATED APPLICATION

This application is a U.S. national stage application of International Application No. PCT/EP2022/077728, filed on Oct. 5, 2022, the contents of each of which are hereby incorporated by reference

### BACKGROUND

The disclosure relates to a container for a mixing device, a mixing device as well as a method for using a mixing device.

In the state of the art many techniques for the purification and processing of cells, DNA and other biomolecules are known. One type of purification is the DNA-extraction, in which the DNA is precipitated in a non-polar environment. DNA can also be purified via centrifugation, e.g. after a cell lysis or via electrophoretic techniques.

Biomolecules can also be synthesized and purified by immobilization on an insoluble carrier. Common substrates to immobilize biomolecules are glass as well as other less common substrates such as gold, platinum, oxides, semiconductors and diverse polymer substrates.

### SUMMARY

It has been determined that manual purification and processing requires too much time in numerous operations those processes now happen fully automated. Thus, so called “magnetic beads” (magnetic particles/magnet particles) play a big part in the automation of laboratory techniques.

“Magnetic bead-based clean-up” and “magnetic bead-based normalization” are prevalent methods for the immobilization, purification and adjustment of the concentration of nucleic acids. Typical fields of applications of those methods are the preparation of samples in the context of DNA-sequencing or DNA-detection (e.g. by PCR, English: polymerase chain reaction, German: Polymerase-Kettenreaktion).

The magnetic particles were developed for the purification of PCR-products at the Whitehead Institute in 1995. The magnetic particles are usually paramagnetic and can e.g. be made of polystyrene which is coated with iron. Different molecules with carboxyl groups can then be applied on the iron. These carboxyl groups can bind the DNA-molecules reversibly. The DNA-molecules are thereby immobilized.

Methods with magnetic particles usually comprise the following steps. First the PCR-products are bound to the magnetic particles. In this process, a mixing of the liquid and the magnetic particles contained within generally happens. Subsequently, the magnetic particles with the affixed PCR-products are separated from contaminants (this step is realized, for example, by pipetting off the solution from the solids/from the container). Then, the magnetic particles with the affixed PCR-product are washed. After washing, the PCR-products are eluted from the magnetic particles and transferred onto a new plate.

In fully automated processes, the necessary reagents are automatically pipetted as a sample and removed again in an isolation process after the introduction of the base material. The magnetic-particle-bound nucleic acids are collected at the bottom and at the rim of the containers and introduced back into the solution in dependence on the routine by optimized pipetting on and off. Finally, the DNA or RNA are eluted into separate vessels with lids for an immediate storage of further applications.

Thus, one of the most important methods for synthesis, normalization and for purification of biomolecules is the method with magnetic particles. Herein the biomolecules are bound to the surface of the magnetic particles. The magnetic particles are then fixed by a magnet and the solution in which by-products and contaminants are present can easily be separated. In this way, the biomolecules can be easily purified and isolated. The advantage of the magnetic beads lies in the fact that the beads can move freely in the trial batch, which is important for the binding steps. If one now wants to remove the liquid from the vessel, e.g. in a washing step, one simply holds a magnet to the container and can then separate the liquid.

The magnetic particles are small paramagnetic or ferromagnetic beads, which are coated with different materials, which impart the required properties. Often, nickel particles are used, which are coated with a plastic.

This procedure allows the isolation of highly pure biomolecules with excellent yields. The underlying method of magnetic particle separation can take place fully automatically in the cavities of the extraction containers used.

In the state of the art, the previously mentioned steps generally take place in bioreactors, in which a mixing of the magnetic particles and the liquid with biomolecules is executed to guarantee as complete a binding of the biomolecules to the magnetic particles as possible. Such bioreactors or mixing devices can however also be used in the processing and the mixing of other biological or chemical substances such as cells, for example.

A corresponding mixing device is known from US 2022/0135924 A1. The mixing device from US 2022/0135924 A1 is supposed to provide optimal conditions with regard to a mixing of a reaction-liquid. The mixing is here based on a change of the internal volume of the reaction container, whereby a movement of the fluid is caused. The change of the internal volume is especially relying on a shape-change of the reaction container, for the purpose of which the reaction-container has at least one flexible area/one flexible region. The flexible area can be a flexible bottom, which is moved by a magnetic drive element, which is connected to the bottom. Hereby, a mixing movement is caused. However, such mixing devices do not guarantee an efficient or complete mixing. In addition, the container of the mixing device must be attached to a base.

It is therefore an objective of the disclosure to provide a container, a mixing device and a method for using a mixing device, which avoid the disadvantageous effects known from the state of the art, in particular which enable a fast, complete and efficient mixing. In particular, it should be possible that in a removed volume of fluid/liquid, there is always a reproducible concentration/amount of, in particular, cells, magnetic particles, molecules or other particles.

### SUBSTITUTE SPECIFICATION-CLEAN VERSION

The objective is met by a container, by a mixing device and by a method for using a mixing device with the features disclosed herein.

According to the disclosure, a mixing device is proposed, which can receive a container having an interior space for receiving a content, or comprises the container, and comprises a first and a second pressing surface. The container of the mixing device according to the disclosure can be arranged between the first and the second pressing surface in such a way that the container can be deformed by the first and/or the second pressing surface, in particular can be deformed by a relative movement to the first and/or the second pressing surface, so that the contents in the interior space are mixable (or can be moved and/or agitated) or can be mixed.

According to the disclosure, a container, in particular a storage container for a mixing device (i.e. in particular for introduction into and/or for use with), is also proposed, wherein the container comprises the interior space for receiving the contents such as a fluid, in particular a liquid, and the container can be deformed in such a way that a content of the container (such as, for example, the fluid/the liquid and further components) (that can be introduced into the interior space) are mixable/can be mixed in the interior space. In addition, the container comprises a holding element with which the container can be suspended, in particular freely-floating suspended and/or suspended in the mixing device. By suspending the container, the container can be flexibly and efficiently deformed by the pressing surface.

It has been found, that by “pressing” (i.e. deforming) the container with the pressing surfaces, a particularly fast and efficient mixing of the contents is made possible. In particular, by using at least two pressing surfaces, between which the container is arranged, a significantly more efficient mixing can be achieved than by using only a single pressing surface. Furthermore, the presence of a headspace during mixing is not necessary. The container can therefore be in particular completely filled.

The deformation of the container takes place preferably by the force exerted by the pressing surfaces. Due to the deformation of the container, a shape of the container or of the interior space is changed in such a way that the contents located in the interior space/that can be introduced into the interior space are influenced. In this process, a pressure is exerted on the contents, in particular the fluid/the liquid, by a wall surrounding the interior space of the container, so that a mixing movement/a flow is induced in the liquid, which leads to the mixing. The shape of the wall surrounding the interior space can therefore be preferably changed or deformed accordingly by the action of the pressing surfaces.

Here, the container can be designed in particular as a “consumable”, i.e. as a consumable material that is introduced into the mixing device and can be disposed of after a corresponding process or procedure has been carried out. Subsequently, a new container can be introduced into the mixing device.

The fact that the container can be arranged between the first and the second pressing surface means in particular that the container can be arranged with at least one portion between at least two pressing surfaces. In practice, the mixing device can comprise a plurality of pressing surfaces, wherein the container can be arranged between at least two of the plurality of pressing surfaces, but also between several or all pressing surfaces. In this context, “deformable” or “to deform” means, in particular, that a shape (of at least a portion) of the container can be changed. For this purpose, the container can be elastic in such a way that the shape of the container can be reversibly changed by a force exerted by the pressing surfaces. For example, the container can be compressed by the force exerted by the pressing surfaces, wherein the shape of the container is not irreversibly changed.

In the context of the disclosure, the fact that the container can be deformed by a relative movement of the first and/or the second pressing surface can mean, in particular, the following:
The container can be deformed after arrangement between the pressing surfaces, in that only one of the two pressing surfaces (e.g. the first) moves and the other pressing surface (e.g. the second) as well as the container remain stationary. Here, the moving pressing surface can move in the direction of the container and/or in the direction of the other pressing surface. Alternatively, or additionally, the moving pressing surface can move along (a wall of) the container or along a container axis of the container, in order to bring about a further mixing; and/or
The container can be deformed after arrangement between the pressing surfaces in that both (or all/several) pressing surfaces move, wherein the container remains stationary. In this case, the pressing surfaces can move in the direction of the container and/or in the direction of the other pressing surface. Alternatively, or additionally, the pressing surfaces can move along (a wall of) the container or along a container axis of the container, in order to bring about a further mixing; and/or
The container can be deformed after arrangement between the pressing surfaces in that the container moves between the pressing surfaces, wherein both (or all) pressing surfaces remain stationary or one or both (or a plurality of pressing surfaces) moves.

In the implementation of the disclosure, the aforementioned points for relative movement can be used alone or in any combination (i.e., both the pressing surfaces and the container can move).

The stationary pressing surface can be realized, for example, by a wall in the mixing device acting as a pressing surface. Additionally, the container can (as previously described) also be arranged so that it can be moved relative to the first and second pressing surfaces in such a way that the container can be deformed by the movement between the first and second pressing surfaces.

Particularly preferably, a distance between the first and the second pressing surface can be adjusted and/or changed, so that the distance between the pressing surfaces is smaller than a first dimension of the container in such a way that the container can be deformed/is deformed (by this relative movement to/by at least one of the pressing surfaces). The force can then act on the container from the pressing surfaces. In this process, particularly the pressing or a squeezing of the container takes place.

The container according to the disclosure is particularly preferred to be chemically resistant, pH-resistant as well as temperature-resistant. The container can additionally be designed for receiving at least 10 ml of liquid/content, preferably 10 ml to 500 ml or 20 ml to 100 ml, especially 20 ml to 50 ml of liquid/content.

In the implementation of the disclosure, the container can further comprise a sheathing (in particular as the aforementioned wall) surrounding the interior space.

Here, the sheathing can be deformed in such a way that at least one dimension of the interior space can be changed. For this purpose, the sheathing can be elastic, and the container can be formed by a bag. In order to ensure a particularly preferred deformability of the container, the container can be designed as the bag, which comprises a polymer, in particular, especially consists of a polymer. Examples of suitable polymers are polyethylene, polypropylene, polyethylene terephthalate and/or polyether ether ketone.

In particular, the sheathing/the wall can be a separate element from the holding element, which is attached to the holding element. In this case, the holding element can be designed as an eyelet, for example, or can comprise an eyelet. Furthermore, the holding element can be designed as a plate from which the sheathing/wall is suspended.

In the implementation of the disclosure, the container can comprise a plurality of walls surrounding separate interior spaces. Here, the holding element can be designed as the plate, which plate comprises a plurality of openings or attachment elements. A sheathing/wall is attached to each of these openings/attachment elements, so that separate cavities are formed. The plate can be supported in the mixing device in particular, so that the individual cavities are suspended in the mixing device. In this case, the container could be designed as a kind of deep-well plate.

Furthermore, the liquid and a plurality of magnetic particles/cells/molecules or other particles can be arranged in the interior space of the container. Here, the liquid and the plurality of magnetic particles/cells/molecules or other particles can be mixed by the deformation of the container. A container prefilled in this way can be provided and sold in particular as a “consumable”. Due to the mixability it is particularly guaranteed, that a concentration of magnetic particles/cells/molecules or other particles is the same for each removed volume of the liquid, which can then be used in procedures for processing biomolecules, for example. The mixing device/the container can particularly be a mixing device/a container for providing a liquid with magnetic particles/cells/molecules or other particles.

The mixing device can comprise a first pressing element and/or a second pressing element, wherein the first pressing element comprises the first pressing surface and/or the second pressing element comprises the second pressing surface.

In a particularly preferred embodiment, the first pressing element can be a first pressing element arranged so as to be rotatable about a first axis. In this case, the first pressing element comprises the first pressing surface in such a way that the first pressing surface can be moved by rotation of the pressing element about the first axis.

Additionally, the second pressing element can be a second pressing element arranged so as to be rotatable about a second axis, wherein the second pressing element comprises the second pressing surface in such a way that the second pressing surface can be moved by rotation of the pressing element about the second axis. Furthermore, in a particularly preferred embodiment, the pressing surfaces can be moved not only by rotation about the corresponding axis, but also by movement with the corresponding pressing element.

The pressing elements can have different shapes, such as the shape of a cuboid. However, the first and/or second pressing element are particularly preferably designed as a roller (i.e. a cylinder), wherein the shell surface corresponds to the pressing surface. In this case, the shell surface rotates around the corresponding axis or the roller in the circumferential direction. In a particularly preferred embodiment, the mixing device comprises at least a first roller as a first pressing element. In addition, a second roller can be used as a second pressing element. In practice, the first axis can be arranged parallel to the second axis. Alternatively, however, it is also possible to provide the further (second) pressing surface by a wall (as a second pressing element) in the mixing device, which in particular can have an inclination or can be inclined. If the container comprises the first and/or second rotatably arranged pressing element, the container and/or at least one of the pressing surfaces can be set in motion by rotation and/or by movement of the first and/or second pressing element in such a way that the container is moved relative to the first and/or second pressing surface. During the movement relative to the pressing surfaces, the container is deformed so that a mixing of the contents that can be introduced into the interior space takes place by the deformation.

The pressing element (or the pressing elements) can be moved to rotate along the container, or the pressing surface/the pressing surfaces can be rolled along a surface of the container. Furthermore, the container can be moved between the first and the second pressing surface, by setting the container in motion by the rotation or by triggering the rotation by moving the container.

Furthermore, the mixing device can comprise a container moving device by which the container can be moved relative to the first and/or the second pressing surface or between the first and the second pressing surface. For this purpose, the container preferably comprises the holding element with which the container is/can be attached to the container moving device. The container moving device can comprise a drive, such as an electric motor, in particular a servomotor, by which the container can be set in motion.

Additionally, the mixing device can comprise a moving device by which the first and/or second pressing surface (or pressing element, respectively) can be moved in such a way that the container can be moved relative to the first and/or the second pressing surface. Here, the moving device can, for example, set the pressing surfaces (or pressing elements) in motion along a pre-determinable path and/or generate a rotation of the pressing surfaces about the first and/or second axis. The moving device can comprise a drive, such as an electric motor, in particular a servomotor, by which the pressing surfaces (or at least one pressing surface) can be set in motion.

In the implementation of the disclosure, the container can comprise an opening for supplying and/or discharging the contents.

In a preferred embodiment, the mixing device can further comprise a magnet, wherein the magnet can be arranged at the container in such a way that magnetic particles that can be introduced into the interior space can be fixed in the container.

This allows the liquid to be discharged and a new liquid to be supplied in without removing the magnetic particles from the interior space. The magnet can be a permanent magnet and/or an electromagnet. An instrument for removing the liquid, such as a pipette, can be used to discharge (or also supply) the liquid, so that the liquid can be removed from the container after the biomolecules have been immobilized at the surface of the magnetic particles. This can be achieved through the opening of the container. The instrument for removing the liquid can also be a valve or another suitable instrument.

The opening (or openings) can thus function as an outlet opening and/or an inlet opening. Advantageously, the opening can be configured such that it can be used as an outlet opening and/or an inlet opening or as a combined inlet opening/outlet opening by closing and opening. Suitably, the opening can be a ball valve, a butterfly valve, a control valve, a diaphragm valve, a gate valve, a needle valve or a pinch valve or a combination thereof.

In practice, the container according to the disclosure and the mixing device are preferably used to provide liquid with magnetic particles for other processes such as processes for the processing of biomolecules (here a constant/reproducible concentration of magnetic particles can be provided for each removed volume of the liquid). Alternatively, the container according to the disclosure can be a reaction container and the mixing device can be a bioreactor, in which biomolecules with magnetic particles are processed.

When used as a reaction container, the magnet can be movably arranged at the container/in the mixing device in such a way, that the magnetic particles are freely movable in the container during a reaction step and are fixed in the container during a washing step by changing the position of the magnet. In particular, the magnet can be movable in such a way that the magnet is arranged in a first position at the container and fixes the magnetic particles and, by moving the magnet to a second position on or around the container, the magnetic particles become movable. Of course, the container can also be moved relative to the magnet in an automated device, for example, and achieve the same effect.

According to the disclosure, a method for using the mixing device is further proposed. Here, the method comprises the following steps. First, the contents are optionally introduced into the interior space of the container. Then, the container with the contents in the interior space is arranged between the first and the second pressing surface and the first and/or the second pressing surface is/are moved relative to the container so that the container is deformed by the relative movement of the first and the second pressing surface and the contents in the interior space are mixed.

The movement of the first and/or the second pressing surfaces relative to the container may comprise that the container and/or the first and/or the second pressing surface is moved.

The method can particularly be a method for providing a liquid with magnetic particles/cells/molecules or other particles, in which method magnetic particles/cells/molecules or other particles and the liquid (as contents) are introduced into the interior space of the mixing device and the liquid and magnetic particles/cells/molecules or other particles are mixed in the interior space. In this process, a predeterminable volume of liquid can be removed from the container, particularly preferably while the mixing is taking place.

Alternatively, the method can be a method for processing biomolecules in a mixing device according to the disclosure, in which method magnetic particles and a liquid with biomolecules (as contents) are introduced into the interior space of the mixing device and the liquid and magnetic particles are mixed in the interior space.

Furthermore, the method can comprise that the magnetic particles in the container are fixed by arranging a magnet at the container and/or the liquid with magnetic particles is removed from the interior space using an instrument for removing the liquid.

In the method according to the disclosure, there is in particular a mixing of the magnetic particles (also magnet particles)/cells/molecules or other particles and the liquid by the interaction of the container and the pressing surfaces of the mixing device, to obtain a liquid with magnet particles/cells/molecules or other particles, which liquid has a constant concentration of magnet particles/cells/molecules or other particles.

Additionally, or alternatively, the relative movement of the container to the pressing surfaces is designed to keep the particles, cells or molecules contained in the interior space in a floating state in such a way that sedimentation at the bottom of the container can be prevented. Furthermore, a mixing process or swirling process is improved by keeping the particles freely floating in the vessel and/or by preventing or decreasing coagulation of beads. Advantageously, allowing the magnetic particles to float freely and/or avoiding a sedimentation of the magnetic particles improves biochemical reactions in the mixing device, namely biomolecule immobilization.

In the context of the present disclosure, the term biomolecule can be understood to mean DNA, RNA, nucleic acids, proteins, starting sequences, monomers or other biologically active molecules. Such biomolecules can be processed in the mixing device according to the disclosure and be introduced into the container according to the disclosure (preferably within a liquid). The processing can have washing steps and/or reaction steps, inter alia, and can be performed with magnetic particles. In the context of the disclosure, a washing step is a procedural step in which the liquid is removed from the container after mixing and in particular the contaminants are separated from the magnetic particles with the affixed biomolecules in this way. Rinsing with a rinsing fluid can also belong to a washing step. In the context of the disclosure, a reaction step is a procedural step, in which the biomolecules which are bound to the magnetic particles are converted, bound to the particles or elongated (chain-elongation, e.g. PCR “polymerase-chain-reaction”). In particular, a contaminant is to be understood as a substance that has not fully reacted or is not bound to the magnetic particles, the solvent, by-products and pollutions, as well as a mixture of two or more of the previously described.

In the context of the disclosure, a liquid can be a solution or a suspension, in particular a mixture of liquid and magnet particles or a reaction mixture made of biomolecules and/or reagents and/or contaminants.

In the context of the disclosure, “magnetic particle” (also “magnetic bead”) can be understood to be a particle in the micrometer or millimeter range. Furthermore, the magnetic particles can be porous. A biomolecule can be bound to the surface of the magnetic particles in particular via thiol groups and/or amino groups and/or hydroxy groups and/or carboxyl groups and/or carbonyl groups and/or ester groups and/or nitrile groups and/or amine groups and/or any other functional groups or other interactions. Magnetic particles can also be coated nickel particles, or any other ferromagnetic or paramagnetic particles. Magnetic particles typically have a diameter of around 1 micrometer. In the context of the disclosure, around 1 micrometer is to be understood as 0.5 to 1.5 micrometers, particularly 0.7 to 1.3 micrometers, especially 0.9 to 1.1 micrometers.

The previously mentioned magnetic particles can thus be functionalized magnet particles, which bind biomolecules such as DNA in a sample material. Subsequently, they can be immobilized by magnetic force and thus be separated from a reagent liquid. The latter is removed and then the biomolecules can be detached from the particles. The magnet particles should preferably be added in an exact amount. The mixing device can be used for the preparation of or in any enzymatic procedure, which contains nucleic acids (e.g. polymerase-chain-reaction (PCR), isothermal DNA-amplification, reverse transcription). The biomolecules bound to the magnetic particles can be detached from the surface of the magnetic particles and be used further afterward.

### BRIEF DESCRIPTION OF THE DRAWINGS

In the following, the disclosure will be explained in more detail on the basis of exemplary embodiments with reference to the drawings.

FIG. 1 is a schematic representation of a first embodiment of a container according to the disclosure;

FIG. 2 is a schematic representation of a first embodiment of a mixing device according to the disclosure;

FIG. 3 is a schematic representation of a second embodiment of a mixing device according to the disclosure;

FIG. 4 is a schematic representation of an embodiment of a mixing device according to the disclosure with two pressing elements;

FIG. 5 is a schematic representation of an embodiment of a mixing device according to the disclosure with a pressing surface and a pressing element;

FIG. 6 is a schematic representation of a first embodiment of a mixing device according to the disclosure with an inclined pressing surface;

FIG. 7 is a schematic representation of a second embodiment of a mixing device according to the disclosure with an inclined pressing surface;

FIG. 8 is a schematic representation of an embodiment of a mixing device according to the disclosure with an instrument for removing the liquid and with a magnet.

### DETAILED DESCRIPTION

A mixing device is in particular a device with a container, in which liquids with magnetic particles can be provided under adjustable, and thus as optimal as possible, conditions. The operation of a mixing device is thus in particular an application of chemistry, biochemistry or biotechnology, which makes chemical and biological processes possible, or provides educts for them.

Factors that can be controlled or monitored in mixing devices are the composition of the contents, the gas supply, temperature, pH-value, sterility and others. The mixing device can serve the providing of a liquid with a predeterminable concentration of magnet particles/cells/molecules or other particles or serve the obtaining and processing of biomolecules. The processing and the breakdown of chemical compounds can also take place in mixing devices.

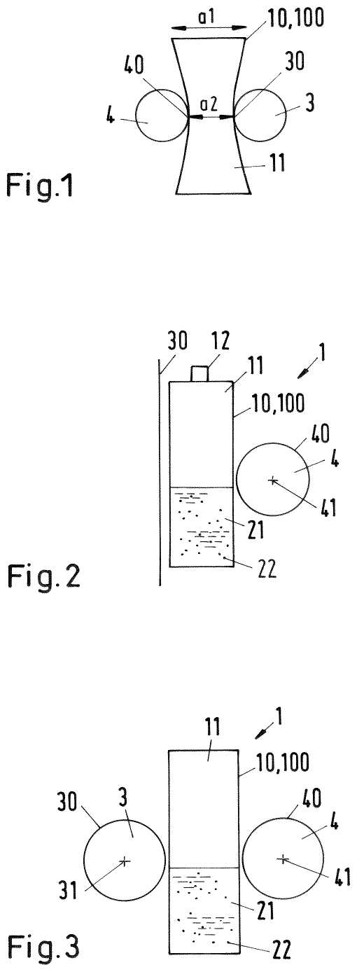

FIG. 1 shows a schematic representation of a first embodiment of a container 10 according to the disclosure for a mixing device. The container 10 comprises an interior space 11, which is suitable for receiving a content, such as a fluid. The container 10 can be deformed in such a way that a content in the interior space can be mixed by the deformation. Pressing elements 3, 4 with pressing surfaces 30, 40 are provided for the deformation.

Here, the deformation of the container 10 takes place by a force exerted by the pressing surfaces 30, 40 of the pressing elements 3, 4. During the deformation, a shape of the container 10 or of the interior space 11 is changed because the container 10 is pressed together by the pressing elements 3, 4.

The pressing together occurs because a distance a2 between the first 30 and the second 40 pressing surface is changed, so that the distance a2 between the pressing surfaces 30, 40 is smaller than a first dimension al of the container 10 in such a way that the container 10 is deformed by this movement of at least one of the pressing surfaces 30, 40.

Due to the pressing together, a pressure is generated on the contents by a wall 100 of the container 10 surrounding the interior space 11, so that a mixing of the contents can take place.

The container 10 can be deformed after arrangement between the pressing surfaces 30, 40, in that one or both pressing elements 3, 4 move towards each other. Alternatively, or in addition, the pressing surfaces 30, 40 can move along the wall 100 of the container 10, so as to displace the pressure point at the container 10 and thus lead to a further mixing. The same effect is produced when the container 10 is moved between the pressing surfaces 30, 40 (up and down).

FIG. 2 shows a schematic representation of a first embodiment of a mixing device 1 according to the disclosure.

The mixing device 1 comprises the container 10 with holding element 12 as well as the first 30 and second 40 pressing surface. Here, the container 10 is arranged between the first 30 and the second 40 pressing surface in such a way that the container 10 can be deformed by a relative movement to the first 30 and/or the second 40 pressing surface, so that a mixing of the contents takes place.

The first pressing surface 30 is designed in the shape of a wall, whereas the second pressing surface 40 is part of the first pressing element 4, which can be rotated about the axis 41 and can thus be moved.

The container 10 can be deformed after arrangement between the pressing surfaces 30, 40, in that the moving pressing surface 40 moves in the direction of the container 10 and in the direction of the other pressing surface 30. The pressing element 4 can rotate about the axis 41 when it is moved along the wall 100, i.e. it can roll along the wall 100.

A liquid 21 and a plurality of magnetic particles 22 are arranged as contents in the interior space 11, wherein the liquid 21 and the plurality of magnetic particles 22 can be mixed by the deformation of the container 10.

It should be noted here that the mixing achieved by squeezing the container is particularly efficient, so that an adjustable and reproducible concentration/concentration/amount of magnetic particles can be removed from the container.

FIG. 3 shows a schematic representation of a second embodiment of a mixing device 1 according to the disclosure.

The mixing device according to FIG. 3 corresponds substantially to the embodiment according to FIG. 2. However, instead of the wall, a pressing element 3 that can be rotated about an axis 31 is used.

Both pressing surfaces 30, 40 can be moved in the direction of the container 10 and rolled along the wall 100 of the container 10.

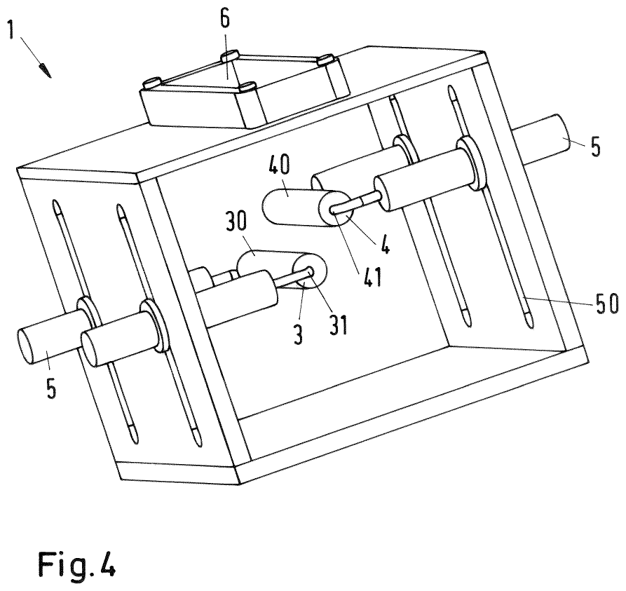

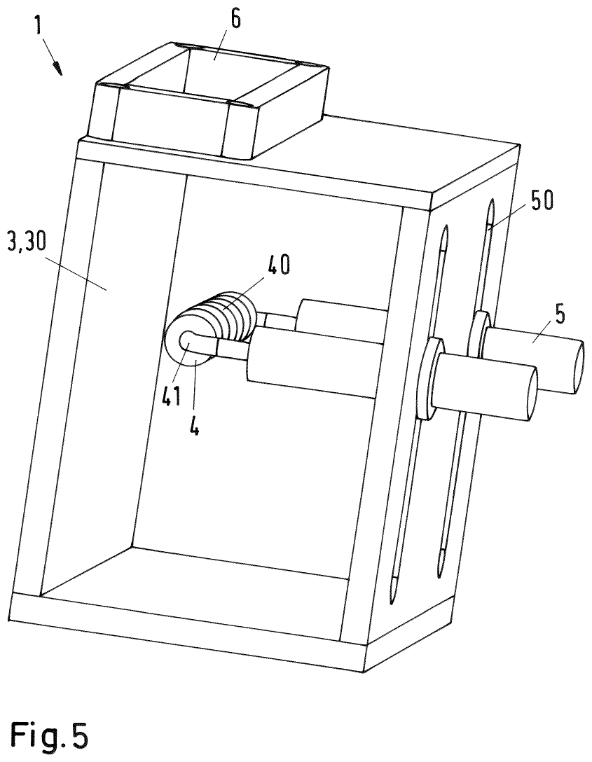

FIG. 4 shows a schematic representation of an embodiment of a mixing device 1 according to the disclosure with two pressing elements 3, 4.

Basically, the structure according to FIG. 4 corresponds to the embodiment according to FIG. 3. The two pressing elements 3, 4 are designed as rotatable rollers 3, 4. The pressing surfaces 30, 40 correspond to the shell surfaces 30, 40 of the rollers 3, 4.

The mixing device 1 further comprises the moving devices 5, by which the rollers 3, 4 can be moved up and down in the mixing device 1 so that the rollers 3, 4 can be moved relative to a container not represented here. The moving devices 5 are moved in rails 51.

In addition, the mixing device 1 comprises an opening 6 through which the container, not represented here, can be introduced from above into the mixing device 1 and between the rollers 3, 4.

After the container has been arranged, the mixing is achieved by deforming the container, with rollers 3, 4 moving towards each other and in opposite directions (i.e. one roller up and one roller down) until the rollers 3 and 4 have moved past each other. Subsequently, the direction of movement can be reversed.

FIG. 5 shows a schematic representation of an embodiment of a mixing device 1 according to the disclosure with a pressing surface 30 and a pressing element 4.

Basically, the structure according to FIG. 5 corresponds to the embodiment according to FIG. 2. However, one pressing element 4 is designed as a rotatable roller 4 with a moving device 5. The other pressing element 3 is a wall 3 of the mixing device 1.

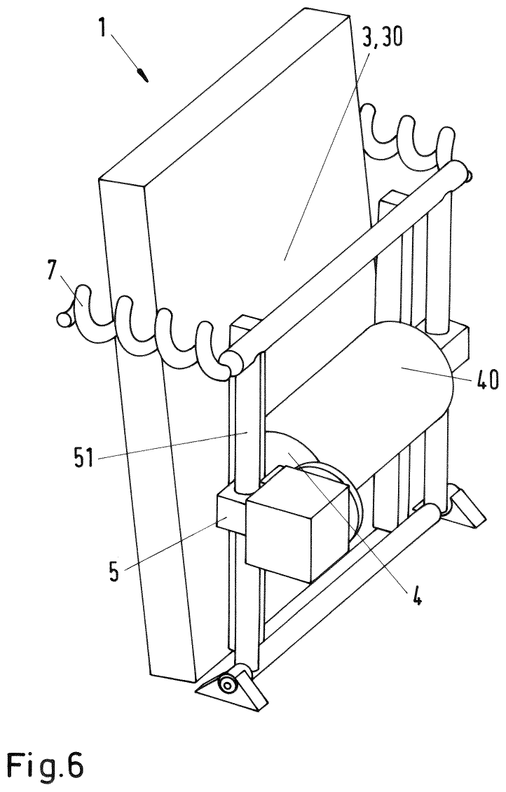

FIG. 6 shows a schematic representation of a first embodiment of a mixing device 1 according to the disclosure with an inclined pressing surface 30.

Here, the pressing surface 30 is a surface of the wall 3. An inclination of the wall 3 can be adjusted by a spacer element 7 so that, after the container, not shown here, has been introduced, the inclination of the wall 100 is reduced, i.e. the wall 3 is moved in the direction of the roller 4, so that a force can be exerted on the container by the wall 3 and the roller 4.

The roller 4 can be moved up and down along the guide rods 51 in the mixing device 1.

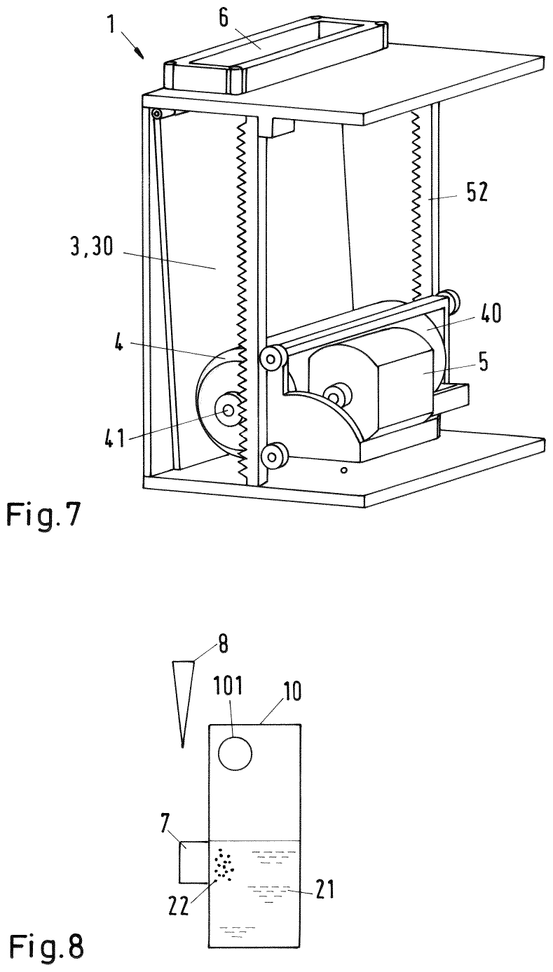

FIG. 7 shows a schematic representation of a second embodiment of a mixing device 1 according to the disclosure with an inclined pressing surface 30.

However, the inclination of the pressing surface 30 of the wall 3 cannot be changed. However, the wall 3 is inclined in such a way that a distance between the roller 4 and the wall 3 is greatest in the area of the opening 6 for supplying the container. Thus, the roller 4 can be arranged at a side of the guide rods 52 facing the opening 6 in order to introduce the container. When the roller 4 is then moved away from the opening 6, a force is exerted on the container due to the decreasing distance between the roller 4 and the wall 3, resulting in a corresponding deformation.

FIG. 8 shows a schematic representation of an embodiment of a mixing device according to the disclosure with an instrument for removing the liquid 8 and with an optional magnet 7.

The mixing device 1 comprises the magnet 7, wherein the magnet 7 is arranged at the container 10 in such a way that magnetic particles 22 in the container 10 are fixed in the container 10. This allows the liquid 21 to be discharged by a pipette 8 via the opening 101 without magnetic particles 22. If no magnet 7 is used, liquid can be removed with a pre-determinable concentration of magnetic particles 22 via the opening 101.

While the disclosure is represented and described in detail in the drawings and the preceding description, such a representation and description must be considered as illustrative or exemplary and not as limiting.

The disclosure is not limited to the disclosed embodiments. Other variations of the disclosed embodiments can be understood and effected by experts when putting into practice of a claimed disclosure from a study of the figures, the disclosure and the dependent claims. In the claims, the word “comprising” does not exclude any other elements or steps, and the indefinite article “a” or “an” does not exclude any plurality. The mere fact that certain measures are repeated in dependent claims which are different from each other, does not mean that a combination of those measures cannot be used advantageously. Any reference signs in the claims should not be interpreted as a limitation of the scope. Furthermore, in particular the measures described above for the first and second pressing surface (or pressing element) can be applied to any plurality of pressing surfaces.

1. A mixing device for receiving a container having an interior space for receiving a content, comprising:
a first pressing surface; and
a second pressing surface;
the container capable of being arranged between the first pressing surface and the second pressing surface such that the container (10) is capable of being deformed by the first pressing surface or the second pressing surface so that the contents in the interior space are mixed.

2. The mixing device according to claim 1, wherein the first pressing surface or the second pressing surface is capable of being moved such that the container is capable of being deformed by the movement of the first pressing surface or the second pressing surface.

3. The mixing device according to claim 1, wherein the container is capable of being moved such that the container is capable of being deformed by the movement between the first pressing surface and the second pressing surface.

4. The mixing device according to claim 1, further comprising a first pressing element arranged so as to be rotatable about a first axis, the first pressing element comprising the first pressing surface such that the first pressing surface is capable of being moved by rotation of the pressing element about the first axis.

5. The mixing device according to claim 4, further comprising a second pressing element arranged so as to be rotatable about a second axis, the second pressing element comprising the second pressing surface such that the second pressing surface is capable of being moved by rotation of the pressing element about the second axis.

6. The mixing device according to claim 5, wherein the first axis is arranged parallel to the second axis.

7. The mixing device according to claim 1, further comprising a container moving device configured to move the container between the first pressing surface and the second pressing surface.

8. The mixing device according to claim 1, further comprising a moving device configured to move the first pressing surface or the second pressing surface.

9. The mixing device according to claim 1, wherein the container comprises an opening to supply or discharge the contents.

10. The mixing device according to claim 1, wherein a distance between the first pressing surface and the second pressing surface is capable of being adjusted or changed, so that the distance between the pressing first and second surfaces is smaller than a first dimension of the container such that the container is capable of being deformed.

11. The mixing device according to claim 1, wherein the container is one of a plurality of the containers capable of being arranged between the first pressing surface and the second pressing surface such that the plurality of the containers is capable of being deformed by the first pressing surface of the second pressing surface.

12. The mixing device according to claim 1, further comprising a magnet, the magnet configured to be arranged at the container such that magnetic particles capable of being introduced into an interior space are configured to be fixed in the container.

13. The mixing device according to claim 12, wherein the magnet is a permanent magnet or an electromagnet.

14. The mixing device according to claim 1, further comprising an instrument configured to remove the contents.

15. A container for the mixing device according to claim 1, the container comprising:
an interior space to receive the contents and the container is configured to be deformed such that the contents in the interior space is mixed; and
a holding element configured to suspend the container.

16. The container according to claim 15, wherein the container is configured to be attached to a suspension device or a container moving device by the holding element.

17. The container according to claim 15, comprising a wall (100) surrounding the interior space, the wall configured to be deformed such that at least one dimension of the interior space is changed.

18. The container according to claim 15, wherein a liquid and a plurality of magnetic particles or cells are arranged in the interior space, the liquid and the plurality of magnetic particles or cells configured to be mixed by deformation of the container.

19. The container according to claim 15, wherein the container is a bag and comprises a polymer.

20. The container according to claim 15, wherein the interior space is one of a plurality of interior spaces and the container comprises a plurality of separate walls surrounding the plurality of interior spaces.

21. A method for using the mixing device according to claim 1, the method comprising:
arranging the container with the contents in the interior space between the first pressing surface and the second pressing surface;
moving the first pressing surface or the second pressing surface relative to the container, so that the container is deformed by the relative movement of the first pressing surface or the second pressing surface and the contents in the interior space are mixed.

22. The method according to claim 21, wherein the movement of the first pressing surface or the second pressing surface relative to the container comprises that the container or the first pressing surface or the second pressing surface is moved.

23. The method according to claim 21, wherein the contents comprise magnetic particles and a liquid and the magnetic particles and the liquid are mixed in the interior space.

24. The method according to claim 23, further comprising
fixing the magnetic particles in the container by arranging a magnet at the container.

25. The method according to claim 23, further comprising
removing the liquid with an instrument for removing the liquid.
